(19) United States
(12) Patent Application Publication
(10) Pub. No.: US 2012/0110383 A1
(43) Pub. Date: May 3, 2012

(54) Method and apparatus for off-line analyzing crashed programs

(75) Inventors: Taiyun Wang, Hsinchu Science Park (TW); Lijun An, Hsinchu Science Park (TW)

(73) Assignees: HT mMobile Inc., Hsinchu Science Park (TW); Sunplus Technology Co., Ltd., Hsinchu (TW)

(21) Appl. No.: 13/067,428

(22) Filed: Jun. 1, 2011

(30) Foreign Application Priority Data
Oct. 29, 2010 (CN) 201010536351.6

(51) Int. Cl. G06F 11/07

(52) U.S. Cl. 714/34; 714/E11.029

(57) ABSTRACT

In a method for off-line analyzing crashed programs, a simulator of a debugger is made to enter into a running state, and set breakpoints in the running state. Register and memory signals are separated from a dump signal outputted by a platform during crash. The debugger is used to replace, at the breakpoints, register and memory signals of the simulator originally in the running state with the register and memory signals separated from the dump signal. A debugging signal in the running state is replaced with a debugging signal during crash. The debugger is used to analyze reasons of crash based on the debugging, register, and memory signals after replacement. By separating the register and memory signals from the dump signals outputted by the platform during crash without involving any OS signal, there is no need to modify the platform and the GDB debugger when analyzing the reasons of crash.

### BACKGROUND OF THE INVENTION

1. Field of the Invention

The present invention relates to a method for analyzing crashed programs and, more particularly, to a method and apparatus for off-line analyzing crashed programs.

2. Description of Related Art

One process in program debugging is to analyze crashed programs to thereby find the reason of crash. Program debugging tool kits typically include a debugger to analyze the reason of crash. In commonly used debuggers, some of them are provided with a simulator, and some are not. For a debugger with a simulator, the simulator is commonly used to perform a command-level debugging, not available for a program with hardware codes. In current techniques, some of them load the dump signals comprised of register, memory, and operating system (OS) signals onto a debugger for inspection.

There are two manners on program debugging, i.e., online and off-line debugging.

The online debugging directly connects a debugger with a circuit board in a wired or wireless manner to thereby debug a program running on the circuit board. However, in the process of implementing the present invention, the following issues are found:

(1) At a certain instant, a crashed program is present just when a debugger and a circuit board are disconnected. Such a condition causes the debugger to be unable to retrieve the running-time information associated with the crashed program, so the difficulty in analyzing the reason of crash is increased for a program tester.

(2) When real-time connecting some debuggers with a circuit board in a situation of, for example, 3G and aviation becomes more difficult, a program is crashed at random and non-replicate, so that the difficulty of online debugging is increased.

For example, it is not ensured that a target mobile phone during a test can connect a debugger in real time. When a mobile phone gets online, an Internet service provider offers a new distributed flash plug-in to thereby cause a crashed program on the mobile phone, and the crashed program on the mobile phone is not reproduced as the new distributed flash plug-in is removed from the Internet, so that a tester cannot detect errors which exist in programs, and the programs with the new distributed flash plug-in used in mobile phones are crashed.

(3) It is more difficult to perform an online test by a programmer and a tester that are separated a certain distance to each other.

Namely, the circuit board locates at the programmer's place, and the debugger locates at the tester's place, so the online test is difficult to be realized for the separated programmer and tester.

On the other hand, the off-line debugging directly operates the debugging signals and dump signals on a debugger when a crash occurs, thereby analyzing the reason of the crash. However, the off-line debugging has the disadvantages as follows.

For various platforms for operating in a circuit board, the stored dump signals include signals associated with an operating system, so the formats of the stored dump signals are different. For a debugger to support the dump signals of the various platforms, it needs to relatively modify the platforms and the debugger. Thus, in order to complete the analysis on the reason of crash, the platforms and the debugger are required to be modified to produce the dump signals supportable by the debugger.

In addition, the operating platform of programs is kept in steady; i.e., the operating platform of programs is not often changed, but the version of a debugger is continuously updated. Accordingly, in order to overcome the conflict between a debugger and a platform on file format support, it still needs to modify the debugger or platform, and modification of the debugger requires a huge of human resources and time. For an example of modifying a GDB debugger, a technician familiar with the GDB debugger is required, and a large amount of time is also required for modifying the complicated instructions.

As cited, since the existing techniques require continuously modifying the platforms and debuggers to thereby realize the analysis on the reason of crash. Such a way has the disadvantages of more difficulty, higher cost, and longer time. Therefore, it is desirable to provide an improved method and apparatus for off-line analyzing crashed programs so as to mitigate and/or obviate the aforementioned problems.

### SUMMARY OF THE INVENTION

The object of the present invention is to provide a method for off-line analyzing crashed programs, which can eliminate the disadvantages of having more difficulty, higher cost, and longer time caused by continuously modifying the platforms and debuggers for realizing an off-line analysis in the prior art.

To achieve the object, the invention provides a method for off-line analyzing crashed programs. The method includes the steps of: entering a simulator of a debugger into a running state, and setting breakpoints in the running state; separating register and memory signals from a dump signal outputted by a platform during crash; using the debugger to replace, at the breakpoints, register and memory signals of the simulator originally in the running state with the register and memory signals separated from the dump signal; replacing a debugging signal in the running state with a debugging signal during crash; and using the debugger to analyze reasons of crash based on the debugging, register, and memory signals after replacement.

To achieve the object, the invention provides an apparatus for off-line analyzing crashed programs. The apparatus includes: a simulator for entering into a running state and setting breakpoints in the running state; a scheduler for separating register and memory signals from a dump signal outputted by a platform during crash, replaces register and memory signals of the simulator originally in the running state with the register and memory signals separated from the dump signal at the breakpoints, and replaces a debugging signal originally in the running state with a debugging signal during crash; and a debugger for analyzing reasons of crash based on the debugging, register, and memory signals after replacement.

The invention separates the register and memory signals from the dump signal outputted by the platform during crash, without involving any OS signal. Since the OS signal is filtered out, a preset startup program is used to enter the simulator into a running state in order to replace, at the breakpoints, register and memory signals of the simulator originally in the running state with the register and memory signals separated from the dump signal, and replace the debugging signal originally in the running state with the debugging signal during crash, so that the analysis on the reason of crash is completed based on the debugging, register, and memory signals after the replacement. Since the OS signal is not included, modifying the platform and GDB debugger is not required even when the platform or GDB debugger is changed or updated. Therefore, the difficulty, cost, and time of the off-line analysis are reduced.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method for off-line analyzing crashed programs according to a first embodiment of the invention;

FIG. 2 is a schematic view of an analysis interface for a crashed program according to the invention;

FIG. 3 is a flowchart of a method for off-line analyzing crashed programs according to a second embodiment of the invention; and

FIG. 4 is a block diagram of an apparatus for off-line analyzing crashed programs according to the invention.

### DETAILED DESCRIPTION OF THE PREFERRED EMBODIMENT

For understanding the present invention, a preferred embodiment of the invention is described below.

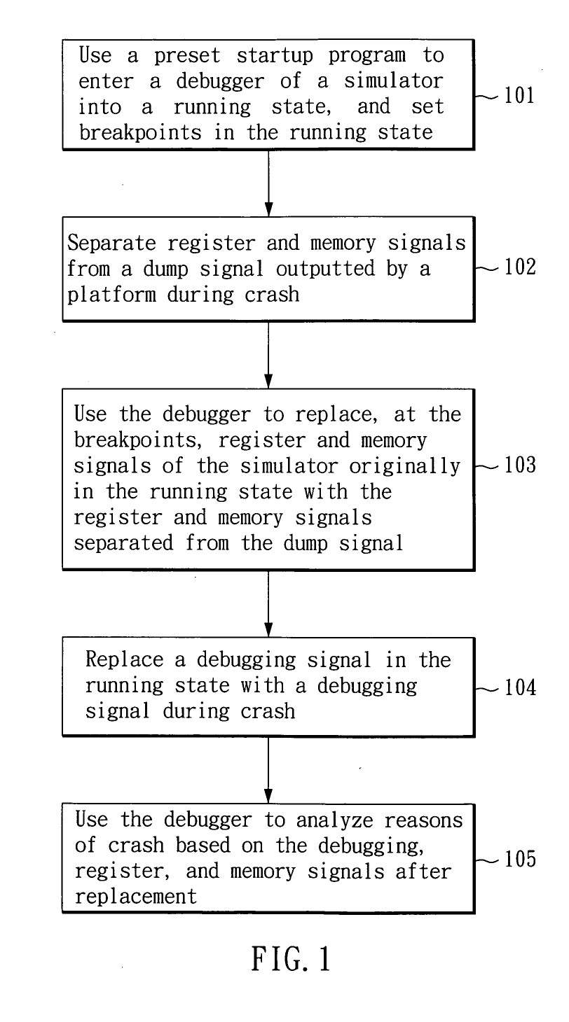

FIG. 1 is a flowchart of a method for off-line analyzing crashed programs according to a first embodiment of the invention. As shown in FIG. 1, the method includes the steps as follows.

Step 101 is provided to enter a simulator into a running state based on a preset startup program and set breakpoints in the running state.

The debugger in this embodiment can be a GDB (GNU DEBUGGER, abbreviated as GDB) debugger. The format supported by the GDB debugger can be an executable and linkable format (hereinafter abbreviated as ELF). The simulator changes from an inactive state to the running state in order to replace register and memory signals at the breakpoints. Correspondingly, one or more preset startup programs can be an ELF format and defined with reference to hardware and software environments of the simulator. If the simulator is integrated with peripherals, it is applicable to operate by visiting the startup programs corresponding to the peripherals. Conversely, if the simulator is not integrated with peripherals and supports only a set of CPU instructions, the startup programs are consisted of the CPU instructions only. In this embodiment, a preset startup program can be a simple ELF file such as “hello, world”. The GDB debugger is used to set the breakpoints and further to modify register and memory signals at the breakpoints.

In this embodiment, since the OS signal is filtered out, a pseudo elf file, namely, a preset startup program, is used to “cheat” the simulator into entering the running state from the inactive state in order to ensure the breakpoint to be set.

In this embodiment, a simple ELF file, “hello, world”, is used to enter the running state, and the command “break” supported by the GDB debugger can be used to arbitrarily set the breakpoints at, for example, entrances, assigned tags, or exits of the startup program.

Instead of being limited to support the file of elf format, the GDB debugger is also available for the file of common object file format (abbreviated as COFF).

Step 102 separates register and memory signals from a dump signal outputted by a platform during program crashing.

For the platforms which are hard to realize an off-line debugging or resume from crash, one of the keys to realize off-line debugging is that the platform needs to store memory and register signals in real time during crash. However, in this case, in addition to the memory and register signals, OS signal is also stored. However, different platforms have different OS signals, resulting in that the dump signal is in a different format. In comparison, in this embodiment, register and memory signals are separated from a dump signal outputted by a platform during crash, and signals associated with the operating system are filtered out so that the GDB debugger does not need to read the signals associated with the operating system for an off-line debugging. Accordingly, when the platform is changed, the dump signal used in the off-line debugging is comprised of the register and memory signals, without any OS signal, so that there is no need of modifying the GDB debugger or the platform for format compatibility.

Specifically, step 102 can be divided as follows:

Step 112: The platform outputs a dump signal comprised of at least register, memory, and OS signals during crash.

Step 122: The OS signal is filtered out of the dump signal in order to obtain the register and memory signals.

In this embodiment, the separated memory signal can be partial or all data in the platform. The partial data can be corresponding to some special threads. For example, if the data in a memory is 2 k in size, it only corresponds to the data of a current thread. If the thread involves a level of function call and local variables, such a format is referred to as “MINIDUMP”. All data in the memory can correspond to the data of all threads. For example, all data in 64M memory corresponds to the data of all threads, which involves the executing state and local variables related to each thread and the global variables related to all threads. Such a format is referred to as “FULLDUMP”. The thread-related data can be checked on an interface of the ECLIPSE platform.

In this embodiment, step 122 can be specified as follows:

The OS signal is filtered out of the dump signal through the ECLIPSE platform to thereby obtain the register and memory signals.

The ECLIPSE platform is an open-sourced, Java-based extendable development platform. The ECLIPSE platform itself is only a frame and a set of services for configuring the development environment through plug-in components. An ECLIPSE platform is used in current techniques for off-line debugging, but simply as an interface of inspection tool. However, in this embodiment, the application of the ECLIPSE platform is extended with the formats of plug-in used for filtering the OS signal out of the dump signal.

Alternatively, step 122 may specify a self-defined scheduling platform for filtering the OS signal out of the dump signal.

Namely, a scheduling platform is redefined for filtering the OS signal out of the dump signal outputted by the platform during crash. Compared with the ECCLIPSE platform used for the filtering process, the redefined scheduling platform has a slightly higher cost because reconfiguring the GDB debugger and simulator is required. However, since the ECLIPSE platform itself carries an interface of GDB debugger and supports plug-in extension, it can filter the OS signal out and provide an inspection interface. Therefore, the ECLIPSE platform has a lower cost than the redefined scheduling platform.

Step 103 uses the debugger to replace, at the breakpoints, register and memory signals of the simulator originally in the running state with register and memory signals separated from the dump signal.

According to step 101, a breakpoint is set. Because the GDB itself supports modification of the register and memory signals at the breakpoint, in this embodiment, a command of the GDB debugger is used to replace the register and memory signals originally operated by the running startup program of the simulator with the separated register and memory signals (for example, as cited above, replacing the register and memory signals for running the file “hello, world” by the simulator). That is, the register and memory signals produced by the simulator in the running state at step 101 are replaced by the separated register and memory signals.

For data stored in the memory, both the minimal memory dump MIMIDUMP and the full memory dump FULLDUMP are provided, and the format is different in replacement. For example, for the minimal memory dump MINIDUMP, a command “restore” or “set” can be used to replace memory and register signals, and for the full memory dump FULLDUMP, a command “load” is used to replace a memory data. Specifically, before the command “load” is used to replace memory signals, the memory signals are converted into a file of ELF format. Next, the command “load” performs a batch replacement on memory signals, but the register signals are replaced in a command line format.

During the replacement, upon the difference between the platform and the simulator in both the named registers and the format of stored memory data, the separated register and memory signals are converted in format, and then the register and memory signals after the format conversion can be used to replace the register and memory signals originally in the running state.

For example, “Coredump_reg_{—}0:00000000” in the platform indicates a value of 00000000 in register 0, and is converted as or replaced by “set $r0=0×0” for indicating a value of 0×0 in register r0 supported by the simulator.

The operation sequence is established by the replacement to the register and memory signals “set $r0=0×0” on the simulator.

Step 104 replaces the debugging signal originally in the running state with the debugging signal during crash.

For the GDB debugger, a command “load” is used to replace the debugging signal produced in the running state at step 101.

After the aforementioned steps, the scene of the platform during crash is reloaded into the simulator through a scene recovery, i.e., the signal replacement.

In step 105, the debugger analyzes the causes of crash based on the debugging, registers, and memory signals after the replacement.

Since the separated register and memory signals are restored in the simulator through the signal replacement, the GDB debugger replaces the debugging signal produced when the startup program is in the running state at step 101 with the debugger signal on the platform under crash. There are names, types, mapping addresses, and line numbers of variables in the debugging signal, and the register and memory signals contain the data corresponding to the variables. Therefore, the analysis on the reason of crash is performed with the thread states, local variables, and global variables checked by the GDB debugger and the ECLIPSE platform.

For example, if the GDB debugger checks the debugging signal on the ECLIPSE platform to thus obtain a mapping address ‘0X8000’ corresponding to a variable A, a value of 5 is retrieved from the address by the GDB debugger, but in the original program, the variable A is actually 10. In this case, a call stack command “bt” is used to check the relationship between the function calls of threads to thereby determine which thread and which function call in the thread are wrong.

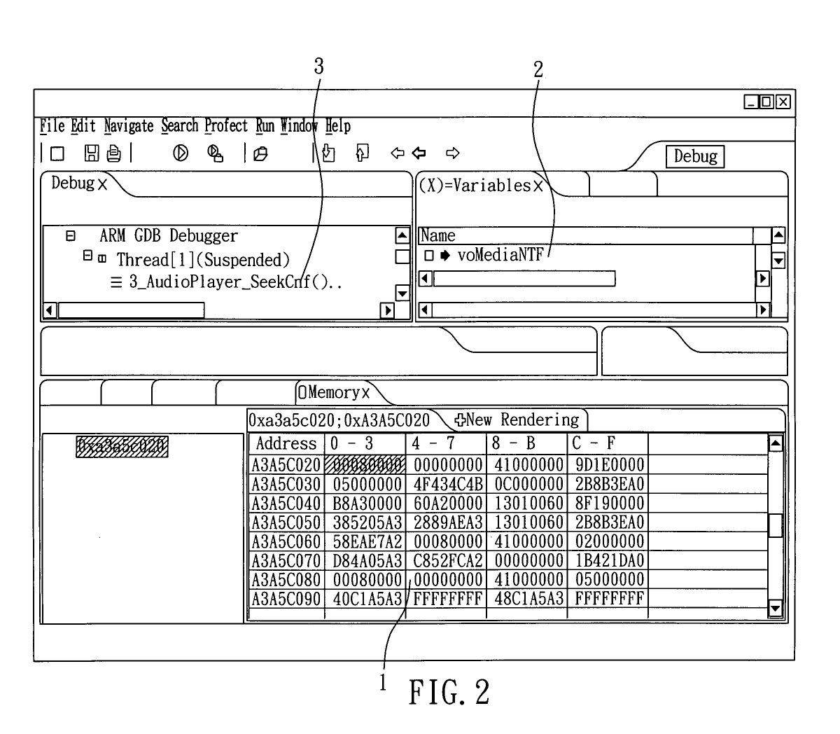

FIG. 2 is a schematic view of an interface for analyzing the reason of crash according to the invention. As shown in FIG. 2, a memory data section 1 is set on the lower part of the interface of the ECLIPSE platform, a variable data section 2 is set on the upper right part, and a thread section 3 is set on the upper left part.

Alternatively, the GDB debugger can be a Windows debugger, which can support a portable executable (abbreviated as PE) format. A startup program's format supported by an XDB debugger can be a COFF format.

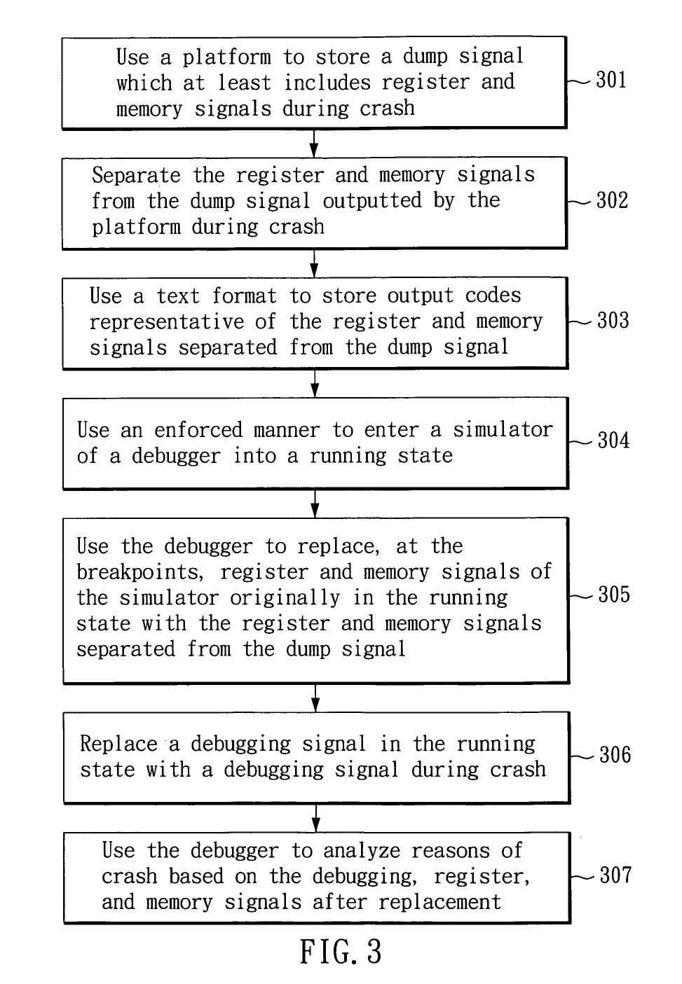

FIG. 3 is a flowchart of a method for off-line analyzing crashed programs according to a second embodiment of the invention. As shown in FIG. 3, the method in this embodiment includes the steps as follows.

In step 301, when a crash occurs, a platform stores a dump signal, which at least includes register and memory signals.

Specifically, for the platform without such a support, the function of storing the dump signal is set thereon. In the dump signal stored by the platform during crash, the memory signal can be partial or all data in the platform during crash.

Step 302 separates the register and memory signals from the dump signal outputted by the platform during crash.

Step 303 stores output codes representative of the separated register and memory signals in a text format.

In this embodiment, the platform requires additional output codes for outputting the output codes representative of the separated register and memory signals. Thus, the text format is employed to prevent the output codes from being damaged by the crashed program.

In this embodiment, the output codes are stored in text format for the minimal core memory dump MINIDUMP, and the output codes are stored in binary format for the full memory dump FULLDUMP. The output codes can be different, depending on the definitions of each user.

Step 304 uses an enforced manner to make the simulator of the debugger enter in the running state.

In this embodiment, the debugger is an XDB debugger which can support a startup program of COFF format.

Different from the first embodiment, another debugger in this embodiment is used to enforce the debugger, which performs an analysis on the reason of crash, to control the symbols to be available in the symbolic simulator at the running state.

In addition to the enforced manner, a crashed program is activated to make the simulator of the debugger enter in the running state. The crashed program is defined based on hardware and software environments planned by the simulator. When the activated crashed program does not include codes to visit peripherals, the simulator activating the crashed program is made to enter directly into the running state. When the activated crashed program includes codes to visit peripherals, a simulator with the peripherals is selected to enter into the running state.

Step 305 uses the debugger to replace the register and memory signals of the simulator originally in the running state with the register and memory signals separated at the breakpoints.

Correspondingly, in the replacement, the register and memory signals in text format are converted into the COFF format. The register signal can further include a co-processor signal.

Step 306 replaces a debugging signal originally in the running state with the debugging signal during crash.

In Step 307, the debugger performs an analysis on the reason of crash based on the debugging, register, and memory signals after the replacement.

In this embodiment, the debugging signal and the target source code are stored as a complete elf file. Furthermore, the target source code contains a code for visiting hardware. The code for visiting the hardware is added with the debugging signal into the simulator. In comparison, the code added into the simulator in the prior art is simply command-level code, but not including the code for visiting hardware.

In this embodiment, the XDB debugger is not limited to support the files of COFF format.

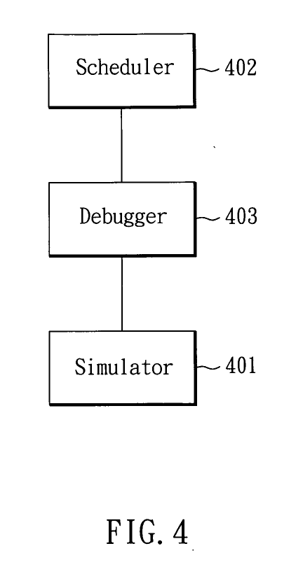

FIG. 4 is a block diagram of an apparatus for off-line analyzing crashed programs according to the invention. As shown in FIG. 4, the apparatus includes a simulator 401, a scheduler 402, and a debugger 403. The simulator 401 is activated to enter in a running state and set breakpoints in the running state. The scheduler separates register and memory signals from a dump signal outputted by a platform during crash, replaces register and memory signals of the simulator originally in the running state with the register and memory signals separated from the dump signal at the breakpoints, and replaces a debugging signal originally in the running state with a debugging signal under crash. The debugger analyzes reasons of the crash based on the debugging, register, and memory signals after the replacement.

In the embodiments, the register and memory signals are separated from the dump signal outputted by the platform during crash, without involving any OS signal. The simulator enters in the running state in order to set a breakpoint for replacing, at the breakpoint, register and memory signals of the simulator originally in the running state with register and memory signals separated from the dump signal, and replacing the debugging signal originally in the running state with the debugging signal during crash. Therefore, the analysis on the reason of crash is completed based on the debugging, register, and memory signals after the replacement. Since the analysis is based only on the replaced register and memory signals, without involving the OS signal, modifying the platform and GDB debugger is not required even when the platform or GDB debugger is changed or updated. Therefore, the difficulty and cost of the off-line analysis are reduced, and the time of the off-line analysis is decreased.

In view of the foregoing, it is known that the invention can be used in many applications in which a real-time connection between the GDB debugger and a circuit board cannot be established, such as a mobile phone test, a multimedia player test, or a test performed by a programmer and a tester on different locations.

Although the present invention has been explained in relation to its preferred embodiments, it is to be understood that many other possible modifications and variations can be made without departing from the spirit and scope of the invention as hereinafter claimed.

What is claimed is:

1. A method for off-line analyzing crashed programs, comprising the steps of:
entering a simulator of a debugger into a running state, and setting breakpoints in the running state;
separating register and memory signals from a dump signal outputted by a platform during crash;
using the debugger to replace, at the breakpoints, register and memory signals of the simulator originally in the running state with the register and memory signals separated from the dump signal;
replacing a debugging signal in the running state with a debugging signal during crash; and
using the debugger to analyze reasons of crash based on the debugging, register, and memory signals after replacement.

2. The method as claimed in claim 1, wherein the step of entering a simulator of a debugger into a running state comprises the step of:
using a preset startup program defined by hardware and software environments planned by the simulator to enter the simulator of the debugger into the running state.

3. The method as claimed in claim 1, wherein the step of entering a simulator of a debugger into a running state comprises the step of:
using an enforced manner to enter the simulator of the debugger into the running state; or activating a crashed program defined by hardware and software environments planned by the simulator to enter the simulator of the debugger into the running state.

4. The method as claimed in claim 2, wherein the debugger is a GDB debugger, and the startup program has a format of executable and linking format (ELF).

5. The method as claimed in claim 2, wherein the debugger is a XDB debugger, and the startup program has a format of common object file format (COFF).

6. The method as claimed in claim 2, wherein the breakpoints are placed at entrances, assigned tags, or exits of the startup program.

7. The method as claimed in claim 1, further comprising the step of using the platform to store the dump signal, which contains at least the register and memory signals of the platform, before the step of separating register and memory signals from a dump signal outputted by a platform during crash.

8. The method as claimed in claim 7, wherein the memory signal indicates partial or all data in a memory of the platform during crash, and the register signal includes a co-processor signal.

9. The method as claimed in claim 8, wherein the step of separating register and memory signals from a dump signal outputted by a platform during crash comprises the step of:
using a text format to store output codes representative of the register and memory signals separated from the dump signal.

10. The method as claimed in claim 8, wherein the step of using the debugger to analyze reasons of crash based on the debugging, register, and memory signals after replacement comprises the step of:
checking a level of function call of a crashed thread and local variables corresponding to the crashed thread, or checking running states, local variables, and global variables of all threads.

11. The method as claimed in claim 1, wherein the step of separating register and memory signals from a dump signal outputted by a platform during crash further comprises the step of:
filtering an operating system signal out of the dump signal so as to separate the register and memory signals.

12. The method as claimed in claim 11, wherein the step of separating register and memory signals from a dump signal outputted by a platform during crash further comprises the step of:
using an ECLIPSE platform to filter the operating system signal out of the dump signal, or using a self-defined scheduling platform to filter the operating system signal out of the dump signal.

13. An apparatus for off-line analyzing crashed programs, comprising:
a simulator for entering into a running state and setting breakpoints in the running state;
a scheduler for separating register and memory signals from a dump signal outputted by a platform during crash, replaces register and memory signals of the simulator originally in the running state with the register and memory signals separated from the dump signal at the breakpoints, and replaces a debugging signal originally in the running state with a debugging signal during crash; and
a debugger for analyzing reasons of crash based on the debugging, register, and memory signals after replacement.
